(19) United States
(12) Patent Application Publication
(10) Pub. No.: US 2016/0365993 A1
(43) Pub. Date: Dec. 15, 2016

(54) CODEWORD-TO-LAYER MAPPING FOR MIMO TRANSMISSIONS

(71) Applicant: TELEFONAKTIEBOLAGET LM ERICSSON (PUBL), Stockholm (SE)

(72) Inventors: Maomao CHEN, Arlöv (SE); Fredrik NORDSTROM, Lund (SE)

(73) Assignee: Telefonaktiebolaget LM Ericsson (publ)

(21) Appl. No.: 14/911,657

(22) PCT Filed: Jan. 27, 2016
(86) PCT No.: PCT/EP2016/051637

§ 371 Date: Feb. 11, 2016

Related U.S. Application Data
(60) Provisional application No. 62/110,698, filed on Feb. 2, 2015.
(60) Provisional application No. 62/110,708, filed on Feb. 2, 2015.

(51) Int. Cl. H04L 25/03; H04L 5/00; H04B 7/04

(52) U.S. Cl. CPC H04L 25/03929; H04B 7/0413; H04B 7/0482; H04L 25/03936; H04L 5/0007; H04L 5/005; H04W 88/02

(57) ABSTRACT

A method of a wireless communication device adapted to receive MIMO signals from a network node of a cellular communication network is disclosed. The MIMO signals comprises a variable number P of codewords conveyed by a variable number Q of MIMO layers, Q>P and P>1. The method comprises selecting a preferred mapping scheme for codeword-to-layer mapping based on a preferred number of layers and a channel quality metric related to the transmission of the MIMO signals, the preferred mapping scheme being selected among a plurality of available codeword-to-layer mapping schemes. The method also comprises transmitting an indication of the preferred mapping scheme to the network node. A related method for the network node is also disclosed.

### TECHNICAL FIELD

The present application relates to mapping of codewords to layers in a multiple-input multiple output transmission system.

### BACKGROUND

It is well known that MIMO (multiple-input multiple-output) systems can significantly increase the data carrying capacity of wireless systems. For these reasons, MIMO is an integral part of the 3rd and 4th generation wireless systems. Multiple antennas for transmission and reception are used as advanced antenna technique for improving both user throughput and cell throughput and are key factors behind the high performance offered by 3GPP UMTS LTE (Third Generation Partnership Project, Universal Mobile Telecommunication—Standard Long Term Evolution). Starting from Rel-10 up to 8 layers is supported. Related standardization documents include 3GPP TS 25.214 ver. 12.1.0, GPP TS 36.101 ver. 12.6.0, and 3GPP TS 36.211 ver. 12.4.0.

The MIMO technique uses a commonly known notation (M×N) to represent MIMO configuration in terms number of transmit (M) and receive antennas (N). The common MIMO configurations used or currently discussed for various technologies are: (2×1), (1×2), (2×2), (4×2), (8×2) and (2×4), (4×4), (8×4). The configurations represented by (2×1) and (1×2) are special cases of MIMO.

With 4 Rx a 4×4 MIMO system supports up to four layer spatial multiplexing. With 4 Rx AP (4 receiver antenna pairs) an 8×4 MIMO system with four layer spatial multiplexing is capable of utilizing both beam forming and diversity gain in maximum level. These layers can be combined through dynamic beamforming and MIMO receiver processing to increase reliability and range. From a performance point of view the use of 4 Rx AP allows higher UE (User Equipment) data rates in a wide range of scenarios and improved receiver sensitivity in general. Depending on the target SNR region, the transmission scheme used in the eNodeB and the channel conditions, the peak throughput can be doubled compared to dual-layer multiplexing by virtue of additional diversity gain and/or multiplexing gain.

Note that terminology such as NodeB or eNode B and UE should be considering non-limiting and does in particular not imply a certain hierarchical relation between the two; in general “NodeB” (the network node) could be considered as device 1 and “UE” (the wireless communication device) device 2, and these two devices communicate with each other over some radio channel. Herein, we also focus on wireless transmissions in the downlink, but the invention is equally applicable in the uplink.

Codeword to Layer mapping in LTE system

In the context of an LTE system, the general physical channel processing for downlink (DL) is illustrated in FIG. 1 (Overview of physical channel processing).

For transmit diversity, the standard dictates that the layer mapping shall be done according to Table 1. There is only one codeword and the number of layers is equal to the number of antenna ports used for transmission of the physical channel. The notation x^{(l)}(i) denotes symbol i of layer l, the notation d^{(c)}(j) denotes symbol j of codeword c, the notation M^{(c)}_{symb} denotes the number of symbols in codeword c, and M^{layer}_{symb} denotes the number of symbols per layer.

TABLE 1
Codeword-to-layer mapping for transmit diversity

| Number of | Number of | Codeword-to-layer mapping | |
|---|---|---|---|
| layers | codewords | i = 0, 1, . . . , M_{symb}^{layer} − 1 | |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 4 | 1 | x⁽⁰⁾ (i) = d⁽⁰⁾ (4i) x⁽¹⁾ (i) = d⁽⁰⁾ (4i + 1) x⁽²⁾ (i) = d⁽⁰⁾ (4i + 2) x⁽³⁾ (i) = d⁽⁰⁾ (4i + 3) | ${M}_{symb}^{layer} = \{ \begin{matrix}{M}_{symb}^{( 0 )} / 4 & if {M}_{symb}^{( 0 )} mod 4 = 0 \\ ( {M}_{symb}^{( 0 )} + 2 ) / 4 & if {M}_{symb}^{( 0 )} mod 4 \neq 0\end{matrix}$ If M_{symb}⁽⁰⁾ mod4 ≠ 0 two null symbols shall be appended to d⁽⁰⁾ (M_{symb}⁽⁰⁾ − 1) |

For spatial multiplexing, multiple codewords can be mapped to multiple layers depending on the transmission rank scheduled by the eNodeB. In the LTE DL, a hybrid automatic repeat request (HARQ) process is operated for each codeword. Each HARQ process requires an ACK/NAK (acknowledgement/non-acknowledgement) feedback signaling on uplink. To reduce the uplink feedback overhead, only up to two codewords are transmitted even though more than two layers can be transmitted on downlink in a given subframe. The standard dictates that the layer mapping shall be done according to Table 2. The number of layers is less than or equal to the number of antenna ports used for transmission of the physical channel. The case of a single codeword mapped to multiple layers is only applicable when the number of cell-specific reference signals is four or when the number of UE-specific reference signals is two or larger.

TABLE 2
Codeword-to-layer mapping for spatial multiplexing

| | | |
|---|---|---|
| Number of | Number of | Codeword-to-layer mapping |
| layers | codewords | i = 0, 1, . . . , M_{symb}^{layer} − 1 |

| | | | |
|---|---|---|---|
| 1 | 1 | x⁽⁰⁾ (i) = d⁽⁰⁾ (i) | M_{symb}^{layer} = |
| | | | M_{symb}⁽⁰⁾ |
| 2 | 1 | x⁽⁰⁾ (i) = d⁽⁰⁾ (2i) | M_{symb}^{layer} = |
| | | x⁽¹⁾ (i) = d⁽⁰⁾ (2i + 1) | M_{symb}⁽⁰⁾/2 |
| 2 | 2 | x⁽⁰⁾ (i) = d⁽⁰⁾ (i) | M_{symb}^{layer} = |
| | | x⁽¹⁾ (i) = d⁽¹⁾ (i) | M_{symb}⁽⁰⁾ = |
| | | | M_{symb}⁽¹⁾ |
| 3 | 1 | x⁽⁰⁾ (i) = d⁽⁰⁾ (3i) | M_{symb}^{layer} = |
| | | x⁽¹⁾ (i) = d⁽⁰⁾ (3i + 1) | M_{symb}⁽⁰⁾/3 |
| | | x⁽²⁾ (i) = d⁽⁰⁾ (3i + 2) | |
| 3 | 2 | x⁽⁰⁾ (i) = d⁽⁰⁾ (i) | M_{symb}^{layer} = |
| | | x⁽¹⁾ (i) = d⁽¹⁾ (2i) | M_{symb}⁽⁰⁾ = |
| | | x⁽²⁾ (i) = d⁽¹⁾ (2i + 1) | M_{symb}⁽¹⁾/2 |
| 4 | 1 | x⁽⁰⁾ (i) = d⁽⁰⁾ (4i) | M_{symb}^{layer} = |
| | | x⁽¹⁾ (i) = d⁽⁰⁾ (4i + 1) | M_{symb}⁽⁰⁾/4 |
| | | x⁽²⁾ (i) = d⁽⁰⁾ (4i + 2) | |
| | | x⁽³⁾ (i) = d⁽⁰⁾ (4i + 3) | |
| 4 | 2 | x⁽⁰⁾ (i) = d⁽⁰⁾ (2i) | M_{symb}^{layer} = |
| | | x⁽¹⁾ (i) = d⁽⁰⁾ (2i + 1) | M_{symb}⁽⁰⁾/2 = |
| | | x⁽²⁾ (i) = d⁽¹⁾ (2i) | M_{symb}⁽¹⁾/2 |
| | | x⁽³⁾ (i) = d⁽¹⁾ (2i + 1) | |
| 5 | 2 | x⁽⁰⁾ (i) = d⁽⁰⁾ (2i) | M_{symb}^{layer} = |
| | | x⁽¹⁾ (i) = d⁽⁰⁾ (2i + 1) | M_{symb}⁽⁰⁾/2 = |
| | | x⁽²⁾ (i) = d⁽¹⁾ (3i) | M_{symb}⁽¹⁾/3 |
| | | x⁽³⁾ (i) = d⁽¹⁾ (3i + 1) | |
| | | x⁽⁴⁾ (i) = d⁽¹⁾ (3i + 2) | |
| 6 | 2 | x⁽⁰⁾ (i) = d⁽⁰⁾ (3i) | M_{symb}^{layer} = |
| | | x⁽¹⁾ (i) = d⁽⁰⁾ (3i + 1) | M_{symb}⁽⁰⁾/3 = |
| | | x⁽²⁾ (i) = d⁽⁰⁾ (3i + 2) | M_{symb}⁽¹⁾/3 |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 2 | x⁽⁰⁾ (i) = d⁽⁰⁾ (3i) | M_{symb}^{layer} = |
| | | x⁽¹⁾ (i) = d⁽⁰⁾ (3i + 1) | M_{symb}⁽⁰⁾/3 = |
| | | x⁽²⁾ (i) = d⁽⁰⁾ (3i + 2) | M_{symb}⁽¹⁾/4 |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 3) | |
| 8 | 2 | x⁽⁰⁾ (i) = d⁽⁰⁾ (4i) | M_{symb}^{layer} = |
| | | x⁽¹⁾ (i) = d⁽⁰⁾ (4i + 1) | M_{symb}⁽⁰⁾/4 = |
| | | x⁽²⁾ (i) = d⁽⁰⁾ (4i + 2) | M_{symb}⁽¹⁾/4 |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

In the closed-loop spatial multiplexing mode, the eNodeB applies the spatial domain precoding on the transmitted signal taking into account the precoding matrix indicator (PMI) reported by the UE so that the transmitted signal matches with the spatial channel experienced by the UE. The closed-loop spatial multiplexing with M layers and N transmit antennas (N≧M). To support the closed-loop spatial multiplexing in the downlink, the UE typically needs to feedback the rank indicator (RI), the PMI, and the channel quality indicator (CQI) in the uplink as shown in FIG. 2 (Close loop spatial multiplexing). The RI indicates the number of spatial layers that can be supported by the current channel experienced at the UE. The eNodeB may decide the transmission rank, M, taking into account the RI reported by the UE as well as other factors such as traffic pattern, available transmission power, etc. The CQI feedback indicates a combination of modulation scheme and channel coding rate that the eNodeB should use to ensure that the block error probability experienced at the UE will not exceed 10%.

Interference Cancellation Mechanism

For such systems, the optimal maximum-likelihood or Maximum A posteriori Probability (ML/MAP) detection for minimizing the packet error rate using exhaustive search is typically impossible to implement. This is because the MIMO detector's complexity increases exponentially with the number of layers or/and the number of bits per constellation point.

Several suboptimal detector structures have been proposed in literature for reducing the complexity of the MIMO detector. These can be classified into linear and nonlinear detectors. Linear detectors include zero-forcing (ZF) and minimum mean-square error (MMSE) detectors, and the nonlinear receivers include decision feedback, nulling-cancelling and variants relying on successive interference cancellation (SIC). These suboptimal detectors are easy to implement but their packet error rate performance is significantly inferior to that of the optimum MIMO detector. This is because most of these sub optimal detection techniques proposed in literature for cancelling multi antenna interference are proposed with/without channel coding and without utilizing the potential of cyclic redundancy check (CRC). However, in a practical system such as LTE/LTE-Advanced, Wimax, HSDPA (High Speed Downlink Packet Access) etc., the CRC bits are appended before the channel encoder at the transmitter and the check has been done after the channel decoder to know whether the packet is received correctly or not.

FIG. 3 (Multiple codeword MIMO transmitter) shows the transmission side of a MIMO communication system with Nₜ transmit antennas. There are N_{cw} transport blocks. CRC bits are added to each transport block and passed to the channel encoder. The channel encoder adds parity bits to protect the data. Then the stream is passed through an interleaver. The interleaver size is adaptively controlled by puncturing to increase the data rate. The adaptation is done by using the information from the feedback channel, for example channel state information sent by the receiver. The interleaved data is passed through a symbol mapper (modulator). The symbol mapper is also controlled by the adaptive controller. After modulation the streams are passed through a layer mapper and the precoder. The resultant streams are then passed through IFFT blocks. Note that the IFFT block is necessary for some communication systems which implements OFDMA as the access technology (for example LTE/LTE-A, Wi-max). For other systems which implements CDMA as the access technology (for example HSDPA etc), this block is replaced by a spreading/scrambling block. The encoded stream is then transmitted through the respective antenna.

FIG. 4 (Multiple codeword MIMO receiver with interference cancellation) shows a MIMO receiver with interference cancellation, where all the receiver codewords are decoded at once. Once the CRC check is made on all the codewords, the codewords whose CRC is a pass are reconstructed and subtracted from the received signal and only those codewords whose CRC is a fail are decoded. This process is repeated till all the codewords are passed or all the codewords are failed or certain pre-determined number of iterations is reached.

Simulation Results with 2 and 4 Rx AP

With MIMO system with 4Rx AP the performance is improved in a straightforward way as shown in following.

System Level Gains with 4Rx AP

From system level the throughput performance for the mean user bit rate and 5% percentile cell edge user bit rate is shown for TM4 in FIG. 5 (System level results for TM4 based on practical IRC receiver) and for TM10 in FIG. 6 (System level results for TM10 based on practical IRC receiver).

With 2 layers and TM4 the system level performance of 4 Rx is boosted by 200% TP at medium served traffic (60 Mbps/sqkm) for both mean and 5% percentile user bit rate, cf. FIG. 5. For TM10 and 2 layers, cf. FIG. 6, the system level performance of 4 Rx is boosted by 166% TP for mean user bit rate and by 200% TP for 5% percentile user bit rate at medium served traffic (60 Mbps/sqkm).

Link Level Gains with 4Rx

The following link level results (in FIGS. 7—Link level results for TM4 with FRC (fixed reference channels) 16QAM code rate ½ under multi-cell scenario based on practical IRC/MRC receiver, 8—Link level results for TM4 with followed CQI under multi-cell scenario based on practical IRC/MRC receiver, and 9—Link level results for TM4 under single-cell scenario based on practical MRC receiver with FRC and follow CQI) are based on low channel correlation between antennas. The link level results in FIGS. 7 and 8 under multi-cell scenarios are based on the IRC scenario with TM4 on the serving cell and 2 interfering cells. FRC and followed CQI are used respective plots in FIG. 9 using practical MMSE-MRC (minimum mean square error, maximum ratio combining) or MMSE-IRC (minimum mean square error, interference rejection combining) receiver.

It may be observed that even with 2 layers on 4 Rx with diversity gain only the link level performance can be improved substantially: by 5 dB for MMSE-MRC receiver and 7 dB for MMSE-IRC receiver. With full rank as 4 layers with 4 Rx the peak TP (throughput) has boosted to double comparing to 2 layers with 2 Rx at high SINR range.

FIG. 9 shows the link level results for single cell scenario with TM4 based on FRC and followed CQI. With FRC test the results for 4 layers are worse than 2 layers at low SNR range. This is due to the fact that there is no link adaption and hence a forced too high MCS on what the channel can handle. For 4 Rx antennas with 2 layers the diversity gain can still achieve up to 5 dB.

FIGS. 10 (Link level results for TM4 with single-cell scenario based on practical MMSE receiver with follow CQI under Xpol high EPA5) and 11 (Link level results for TM4 with single-cell scenario based on practical SU-MIMO receivers with follow CQI under Xpol high EPA5) illustrate the link level TP results for single cell scenario for different receivers with follow CQI under Xpol high on antenna configuration. FIG. 10 gives results for liner MMSE receiver and FIG. 11 is for SU-MIMO IC receivers as ML and CWIC. In FIG. 10 4×4 with 4 layers is included but it gives worse performance than 2 layer cases. This is due to high correlations between 2 sets of Xpol antennas so only 2 of the 4 layers are actually good enough to demodulate the data. But there are still good gain for 4 Rx AP with 2 layers up to 5 dB observed comparing to 2 Rx AP with 2 layers.

Typical Antenna Configuration in Existing UE Devices

Some typical antenna configuration for LTE UE devices are shown in FIG. 12 (Typical antenna configurations for LTE UE devices with 2 Rx AP). The USB modem for computer is using Xpol (cross polarized), the mobile WiFi device is using ULA and the mobile phone device is using Xpol.

For devices with 4Rx AP some antenna configurations are shown in FIG. 13 (Typical antenna configurations for LTE UE devices with 4 Rx AP): ULA on the left and Xpol on the right.

The existing antenna configurations Uniform Linear Array (ULA) and Cross Polarized (Xpol) are also defined in 3GPP standardization in 3GPP TS 36.101 ver. 12.6.0. Table 3 gives the correlation parameters for ULA where alpha represents the correlation from eNodeB side and beta from UE side.

TABLE 3
Correlation parameters for ULA

| Low correlation | | Medium Correlation | | High Correlation | |
|---|---|---|---|---|---|
| α | β | α | β | α | β |
| 0 | 0 | 0.3 | 0.9 | 0.9 | 0.9 |

Table 4 gives the values for parameters α, β and γ for high spatial correlation for Xpol, where the alpha represents the correlation with in same pair of crossed polarized antennas from eNodeB side, beta represents the correlation with in same pair of crossed polarized antennas from UE side, while gamma represents the correlation between 2 pairs of crossed polarized antennas.

TABLE 4
Correlation parameters for Xpol high
High spatial correlation

| α | β | γ |
|---|---|---|
| 0.9 | 0.9 | 0.3 |

Note 1:
Value of α applies when more than one pair of cross-polarized antenna elements at eNB side.
Note 2:
Value of β applies when more than one pair of cross-polarized antenna elements at UE side.

### SUMMARY

A first aspect is a method of a wireless communication device adapted to receive multiple-input multiple-output—MIMO—signals from a network node of a cellular communication network, the MIMO signals comprising a variable number—P—of codewords conveyed by a variable number—Q—of MIMO layers wherein Q is larger than P and P is larger than 1.

The method comprises selecting a preferred mapping scheme for codeword-to-layer mapping based on a preferred number of layers and a channel quality metric related to the transmission of the MIMO signals, the preferred mapping scheme being selected among a plurality of available codeword-to-layer mapping schemes, and transmitting an indication of the preferred mapping scheme to the network node.

In some embodiments, the method may further comprise determining the preferred number of layers based on the channel quality metric.

In some embodiments, selecting the preferred mapping scheme may comprise determining a preferred number of codewords and selecting the preferred mapping scheme may be further based on the preferred number of codewords.

In some embodiments, the selection of the preferred mapping scheme may be based on the channel quality metric of each of the layers.

In some embodiments, each codeword may be mapped to a number—q—of layers according to the preferred mapping scheme, wherein q is based on an inverse of the channel quality metric of the layers. For example, if there are 4 layers and 2 codewords and a first layer has considerably better channel quality metric than the other three layers, one codeword may be conveyed by the first layer and the other codeword may be conveyed by the other three layers.

In some embodiments, the channel quality metric may comprise a signal-to-interference-and-noise ratio—SINR. Other examples, include SNR, SIR, and functions of SINR, SNR or SIR (e.g. associated with channel capacity). When any of these metrics are referred to herein, it is to be understood that any suitable one of the other metrics may be used instead.

In some embodiments, the indication of the preferred mapping scheme may comprise one or more of:
the preferred number of layers
the preferred number of codewords
an identification of the codeword-to-layer mapping
an identification of layers being associated with a same antenna pair
an identification of layers to be combined to convey a same codeword

In some embodiments, the indication of the preferred mapping scheme may be transmitted in one of a radio resource control—RRC—message, a media access control—MAC—message, and one or more physical transmission layer—PHY—bits.

In some embodiments, P may be equal to 2 and Q may be greater than or equal to 4.

A second aspect is a method of a network node of a cellular communication network, the network node adapted to transmit multiple-input multiple-output—MIMO—signals to a wireless communication device, the MIMO signals comprising a variable number—P—of codewords conveyed by a variable number—Q—of MIMO layers, wherein Q is larger than P and P is larger than 1.

The method comprises receiving, from the wireless communication device, an indication of a preferred mapping scheme for codeword-to-layer mapping, wherein the preferred mapping scheme has been selected by the wireless communication device among a plurality of available codeword-to-layer mapping schemes based on a preferred number of layers and a channel quality metric related to the transmission of the MIMO signals, and mapping the codewords to the MIMO layers according to the preferred mapping scheme for generation of the MIMO signals.

In some embodiments, the method may further comprise discarding the preferred mapping scheme after a predetermined time or when a new indication of preferred mapping scheme is received.

In some embodiments, the method may further comprise transmitting the received indication to another network node.

A third aspect is a computer program product comprising a computer readable medium, having thereon a computer program comprising program instructions. The computer program is loadable into a data-processing unit and adapted to cause execution of the method according to any of the first and second aspect when the computer program is run by the data-processing unit.

A fourth aspect is a wireless communication device adapted to receive multiple-input multiple-output—MIMO—signals from a network node of a cellular communication network, the MIMO signals comprising a variable number—P—of codewords conveyed by a variable number—Q—of MIMO layers wherein Q is larger than P and P is larger than 1.

The wireless communication device comprises a control unit and a transmitter.

The control unit is adapted to select a preferred mapping scheme for codeword-to-layer mapping based on a preferred number of layers and a channel quality metric related to the transmission of the MIMO signals, the preferred mapping scheme being selected among a plurality of available codeword-to-layer mapping schemes.

The transmitter is adapted to transmit an indication of the preferred mapping scheme to the network node.

A fifth aspect is a network node of a cellular communication network, the network node adapted to transmit multiple-input multiple-output—MIMO—signals to a wireless communication device, the MIMO signals comprising a variable number—P—of codewords conveyed by a variable number—Q—of MIMO layers, wherein Q is larger than P and P is larger than 1.

The network node comprises a receiver and a control unit.

The receiver is adapted to receive, from the wireless communication device, an indication of a preferred mapping scheme for codeword-to-layer mapping, wherein the preferred mapping scheme has been selected by the wireless communication device among a plurality of available codeword-to-layer mapping schemes based on a preferred number of layers and a channel quality metric related to the transmission of the MIMO signals.

The control unit is adapted to map the codewords to the MIMO layers according to the preferred mapping scheme for generation of the MIMO signals.

In some embodiments, the various aspects may additionally have features identical with, or corresponding to, any of the various features as explained in connection with any of the other aspects.

### BRIEF DESCRIPTION OF THE DRAWINGS

FIGS. 1-4 show block diagrams for explaining MIMO operation.

FIGS. 5-11 are plots showing performance simulation results for various types of MIMO operation.

FIGS. 12-13 illustrate example of physical antenna placement in various MIMO devices.

FIGS. 14-17 show flowcharts of methods.

FIG. 18 schematically illustrates a message.

FIGS. 19-21 show block diagrams.

FIG. 22 schematically illustrates a computer-readable medium, a data-processing unit, and a memory.

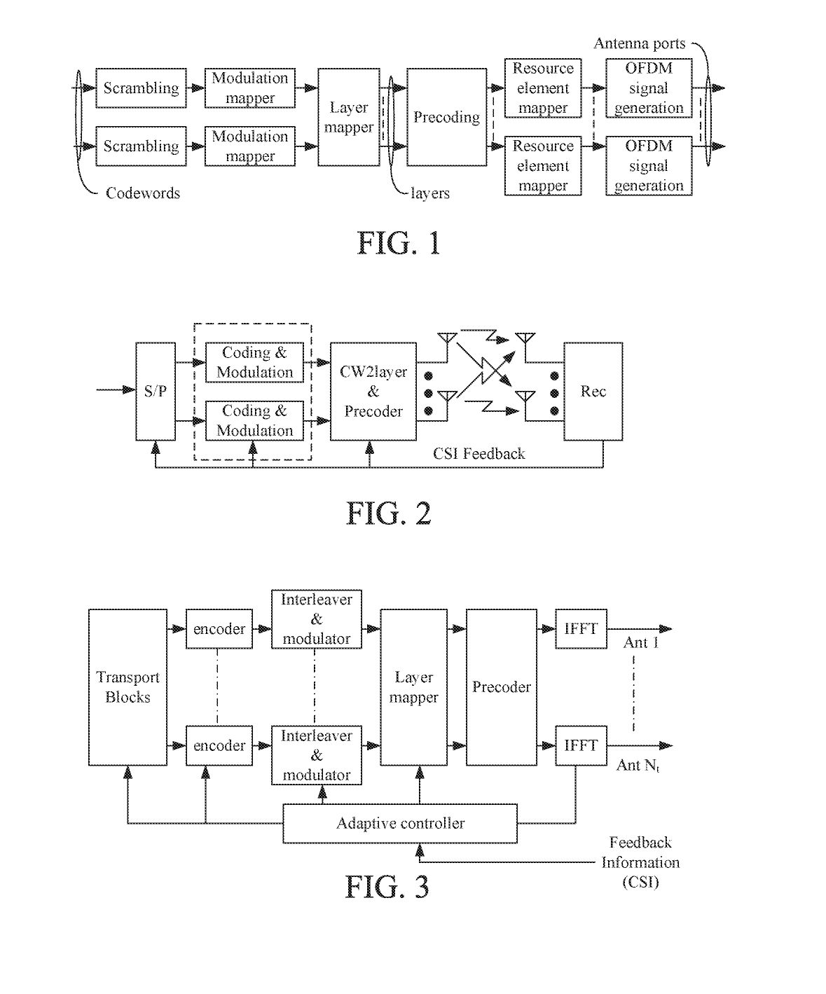

### DETAILED DESCRIPTION

It should be emphasized that the term “comprises/comprising” when used in this specification is taken to specify the presence of stated features, integers, steps, or components, but does not preclude the presence or addition of one or more other features, integers, steps, components, or groups thereof.

It is to be understood that all embodiments and examples described herein are merely illustrative and not limiting.

In the following, methods to report codeword-to-layer mapping in MIMO systems will be described. The inventors have realized drawbacks with using a predetermined codeword-to-layer mapping scheme for a given number Q of layers and a given number P of codewords, for instance as defined in table 2 above. For instance, the inventors have realized that for P≧2 and Q>P, it can be beneficial to have several different mapping schemes to choose from, for example depending on channel quality of the different layers.

A problem with the current codeword-to-layer mapping is that when the UE has multiple Rx APs (larger than 2), the network node (e.g. Node B in HSPA or eNode B in LTE) can utilize the high rank transmission but the current way of codeword-to-layer mapping defined in 3GPP may be not optimized from a UE implementation and channel capacity point of view.

Also, with 4 Rx AP with more layers and high rank the impact from such factors as antenna configuration, correlation, power imbalance among Rx antennas to the CSI measurement can be very different compared to low rank. It has been observed with more than 1 layer, large SNR differences can be observed among layers due to such factors listed. The large difference cannot be reflected by the 3 bits defined in 3GPP to reflect the differential CQI. The difference in SNR between the different layers, for more than two layers, might be large, which will make inefficient transmission if a codeword is mapped to layers with large SNR differences.

Since if the network node does not know some more information about the possible optimized or UE specifically preferred codeword to layer mapping the system, the performance will be decreased.

Example embodiments comprise embodiments that can be implemented in a UE and/or a network node.

According to some embodiments, a method is provided in or for a first UE configured with multiple antennas. The method comprising:
Determining, based on one or more criteria, a number of preferred layers (denoted Y or Q herein, aka RI) to be transmitted to the first UE;
Determining (selecting), based on one or more criteria, an optimized codeword (CW) to layer mapping information (X—preferred mapping scheme) for the first UE;
Transmitting the determined information (X—indication of the preferred mapping scheme) to a first network node and/or to a second network node.

It should be noted that the notation X is used herein as denoting both the preferred mapping scheme and the transmitted indication thereof.

According to some embodiments, a method is provided in or for a first network node and/or a second network node serving or managing the first UE with multiple antennas. The method comprising:
Obtaining information about an optimized codeword to layer mapping information (X) from the first UE; and
Using the obtained information for one or more radio operational tasks (e.g. adapting link adaptation, resource allocation scheduling, multi-antenna configuration of UEs, transmitting to other network nodes, etc.).

Thus, the existing codeword to layer mapping defined in the system may not be optimal for high rank situations. The UE determines the current status of its optimized CW to layer mapping status, and transmits this information to the network node (e.g. serving BS). Then, the network node performs, based on the received information, one or more radio operational tasks leading to more efficient use of radio resources and enhanced system performance

Advantages of some embodiments include:
The network node can utilize radio resources more efficiently while taking into consideration the optimized CW to layer mapping information from one or more UEs.
The network node can adapt link adaptation thereby minimizing the UE and system performance loss.
The network node can adapt the CQI reporting mode using the optimized CW to layer mapping information from one or more UEs.
By introducing this mechanism of reporting the optimized CW to layer mapping it gives more flexibility to the network to more easily change spatial multiplexing and tune beamforming to reach a higher system capacity.

Generalization and Description of Scenario for MIMO

In some embodiments the non-limiting term radio network node or simply network node is used and it refers to any type of network node serving UE and/or connected to other network node or network element or any radio node from where UE receives signal. Examples of radio network nodes are Node B, base station (BS), multi-standard radio (MSR) radio node such as MSR BS, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used and it refers to any type of wireless device communicating with a radio network node in a cellular or mobile communication system. Examples of UE are target device, device to device (D2D) UE, machine type UE or UE capable of machine to machine (M2M) communication, PDA, iPAD, Tablet, mobile terminals, smart phone, laptop embedded equipped (LEE), laptop mounted equipment (LME), USB dongles etc.

The embodiments are described in particular for MIMO operation EUTRA/LTE. The embodiments are however applicable to any RAT or multi-RAT system where the UE operates using MIMO e.g. UTRA/HSPA, GSM/GERAN, Wi Fi, WLAN, WiMax, CDMA2000 etc.

The embodiments are applicable to single carrier as well as to multicarrier (MC) or carrier aggregation (CA) operation of the UE in conjunction with MIMO in which the UE is able to receive and/or transmit data to more than one serving cells using MIMO. The term carrier aggregation (CA) is also called (e.g. interchangeably called) “multi-carrier system”, “multi-cell operation”, “multi-carrier operation”, “multi-carrier” transmission and/or reception.

The receiver for mitigating the multi-antenna inter-stream interference can be based on different kinds of implementation e.g. maximum likelihood (ML) with full blow search, R-ML (reduced complex ML), code word interference cancellation (CWIC) and symbol level IC (SLIC) etc.

Method in UE of Determining and Indicating Status of Optimized CQI Layer Mapping from UE Side

In this embodiment a first UE determines the optimized CW to layer mapping information by the first UE and indicate the associated information to a first network node and/or to a second network node. The steps performed by the first UE comprise:
Determining based on one or more criteria number of preferred layers (Y) to be transmitted to the first UE;
Determining based on one or more criteria the optimized CW to layer mapping information (X) from the first UE;
Transmitting the determined information related to the parameter X to a first network node and/or to a second network node.

These steps are elaborated on below.

Determining Number of Preferred Layers aka Rank Index (RI)

In this step the UE calculate a metric (channel quality metric) for each combination of number of layers and different predefined transmission configurations. Examples of predefined transmission configurations are modulation orders and precoders. The metric (channel quality metric) calculated for each of these configurations can be SNR, SINR, SIR, or a function of any of SNR, SINR, SIR that generates a metric describing the channel capacity. The number of layers (Y, Q) is then determined by choosing configuration that gives the maximum channel capacity.

Determining the Optimized CW to Layer Mapping

In this step the first UE uses one or more criteria to determine the optimized CW to layer mapping information (X) from the first UE. The information X can contain the following elements:
The preferred CW to layer mapping information based on existing CW to layer mapping table, aka preferred number of CW from first UE (X1)
An optimized new CW to layer mapping, differently from the existing CW to layer mapping (X2)
Layer index associated with antenna configuration (X3)
Layer information to be combined into same codeword (X4)

Different demodulation algorithms in the UE may also be suited for different CW to layer mappings. For example linear MMSE might prefer one mapping, CWIC another and ML a third.

Determining the Preferred Number of CW (P) from First UE (X1)

There are circumstances when only one codeword may be preferred to be used instead of 2 codewords. For example when there are big difference on signal levels from 2 codewords due to the reason one of the codewords may experience very bad channel condition, or the receiver antenna configuration status including correlation and power imbalance gives negative impact on one codeword the system performance could be improved by only using one codeword. This might be advantageous for certain receiver types, such as ML receivers. The same scenario described above can also be of great disadvantageous for certain receiver types, e.g. CWIC. For CWIC, which relies on turbo decoding, there is usually better to have two CWs for the two layers if the SNR for the different layers have large difference. This is due to that the turbo decoding works best if the SNR for all the input soft bits are approximately the same.

In yet another embodiment the number of CWs can be determined by distinguish groups of layers that have similar SNR/CQI values, i.e. are within a predefined range such as within maximum distance is e.g. 4 dB. Each group of layers is then coded and transmitted with same modulation and coding scheme. The number of CWs should be kept low to limit the signaling.

Under Carrier Aggregation (CA) scenarios when several DL carriers are used but there is only one UL carrier to transmit ACK/NACK feedback. For this case it can be good use one codeword covering several layers to limit the UL signaling.

Another scenario is under TDD bundling case when there are heavy DL subframes, e.g. UL/DL configuration 5 there is only one UL subframe to transmit ACK/NACK feedback. In such scenarios the system performance could be more robust if only one codeword is used for several layers.

Also to only demodulate and decode one codeword could potentially save UE power so if the UE battery is below a threshold then the first UE may decide to only use one codeword.

Also to only demodulate and decode one codeword could potentially save delay in processing since the UE can starts to decode a code block earlier since data from the code block is spread over several layers. If the UE need a fast ACK/NACK response then the first UE may decide to only use one codeword. Also depending on the first UE receiver design the first UE may decide the preferred number of codeword. SIC receiver works best with multi-codewords. If one of the embodiment above has indicated one codeword the SIC receiver can overrule that choice. With other receiver design, such as ML or MMSE, number of codewords hasn't any impact on performance

Also depending on RI information (Y) it gives indication on number of layers are preferred from the first UE which could help determine X1.

The first UE may use any combination of the criteria mentioned above to decide whether to restrict the number codeword to be used in the system.

The format of X1 can be 1 bit to indicate the preferred number of CW. 0 for 1 codeword and 1 for 2 codewords.

Determining the Preferred CW to Layer Mapping Information with New CW to Layer Mapping Rule (X2)

With multiple codewords to map to different layers there are other mapping rules than the existing ones from Table 2. For example with 2 code words mapped to 4 layers in Table 5 the first row is the existing one (Mode 2-2) and the 2nd row (Mode 1-3) is a new rule where the 1st codeword is mapped to 1st layer while the 2nd codeword is mapped to the rest layers. The new rule gives the possibility for the UE to have a smaller buffer size to decode the first codeword instead of 2 as the legacy way, thus it can dump the decoded data faster after 1st codeword is decoded, compared to a Mode 2-2 CW to layer mapping.

Another advantage of Mode 1-3 is the CQI estimation of the first codeword is always more reflecting the real channel condition than the Mode 2-2 case with 2 layers mapped in one codeword with one CQI reported.

Also for SIC receiver Mode 2-2 requires a 2-layer structure with 2 SIC subtractions while Mode 1-3 only requires 1 SIC. Depending on the receiver design the first UE could determine the preferred CW to layer mapping other than the only existing one.

TABLE 5
Extended CW to layer mapping

| Number of | Number of | Codeword-to-layer mapping | | |
|---|---|---|---|---|
| layers | codewords | i = 0, 1, . . . , M_{symb}^{layer} − 1 | | Mode |
| 4 | 2 | x⁽⁰⁾ (i) = d⁽⁰⁾ (i) | M_{symb}^{layer} = | 2-2 |
| | | x⁽¹⁾ (i) = d⁽⁰⁾ (2i + 1) | M_{symb}⁽⁰⁾/2 = | |
| | | x⁽²⁾ (i) = d⁽¹⁾ (2i) | M_{symb}⁽¹⁾/2 | |
| | | x⁽³⁾ (i) = d⁽¹⁾ (2i + 1) | | |
| 4 | 2 | x⁽⁰⁾ (i) = d⁽⁰⁾ (i) | M_{symb}^{layer} = | 1-3 |
| | | x⁽¹⁾ (i) = d⁽¹⁾ (3i) | M_{symb}⁽⁰⁾ = | |
| | | x⁽²⁾ (i) = d⁽¹⁾ (3i + 1) | M_{symb}⁽¹⁾/3 | |
| | | x⁽³⁾ (i) = d⁽¹⁾ (3i + 2) | | |

The format of X2 can be 1 bit to indicate if new layer mapping rule is preferred by the first UE. 0 stands for old mapping rule and 1 for new rule as Mode 1-3 in Table 5.

Another more flexible method of CW to layer mapping can be also used for information as X2 as shown in Table 6 where there are 3 layers mapped to 2 codewords as an example. There are 2 basic mapping mode as Mode 1-2 and Mode 2-1 where Mode 1-2 maps 1 layer to the first codeword and 2 layers to the second codeword while Mode 2-1 maps 2 layers to the first codeword and 1 layer to the second codeword. Within each Mode there can be flexible combinations of different layers which can depend on the signal levels estimated from each layers. For example if layer 0 and layer 1 have the similar SNR level then these 2 layers should be combined into one codeword as in either Mode 1-2C or Mode 2-1a. Furthermore based on the receiver type can decide which ones gives the most benefit to be chosen. Here the X2 can be the new Mode index to indicate which mapping is the preferred one from first UE.

TABLE 6
Extended CW to layer mapping with 3 layers and 2 codewords

| Number of | Number of | Codeword-to-layer mapping | | |
|---|---|---|---|---|
| layers | codewords | i = 0, 1, . . . , M_{symb}^{layer} − 1 | | Mode |
| 3 | 2 | x⁽⁰⁾ (i) = d⁽⁰⁾ (i) | M_{symb}^{layer} = | 1-2a |
| | | x⁽¹⁾ (i) = d⁽¹⁾ (2i) | M_{symb}⁽⁰⁾ = | |
| | | x⁽²⁾ (i) = d⁽¹⁾ (2i + 1) | M_{symb}⁽¹⁾/2 | |
| 3 | 2 | x⁽¹⁾ (i) = d⁽⁰⁾ (i) | M_{symb}^{layer} = | 1-2b |
| | | x⁽⁰⁾ (i) = d⁽¹⁾ (2i) | M_{symb}⁽⁰⁾ = | |
| | | x⁽²⁾ (i) = d⁽¹⁾ (2i + 1) | M_{symb}⁽¹⁾/2 | |
| 3 | 2 | x⁽²⁾ (i) = d⁽⁰⁾ (i) | M_{symb}^{layer} = | 1-2c |
| | | x⁽⁰⁾ (i) = d⁽¹⁾ (2i) | M_{symb}⁽⁰⁾ = | |
| | | x⁽¹⁾ (i) = d⁽¹⁾ (2i + 1) | M_{symb}⁽¹⁾/2 | |
| 3 | 2 | x⁽⁰⁾ (i) = d⁽⁰⁾ (2i) | M_{symb}^{layer} = | 2-1a |
| | | x⁽¹⁾ (i) = d⁽⁰⁾ (2i + 1) | M_{symb}⁽⁰⁾/2 = | |
| | | x⁽²⁾ (i) = d⁽¹⁾ (i) | M_{symb}⁽¹⁾ | |
| 3 | 2 | x⁽⁰⁾ (i) = d⁽⁰⁾ (2i) | M_{symb}^{layer} = | 2-1b |
| | | x⁽²⁾ (i) = d⁽⁰⁾ (2i + 1) | M_{symb}⁽⁰⁾/2 = | |
| | | x⁽¹⁾ (i) = d⁽¹⁾ (i) | M_{symb}⁽¹⁾ | |
| 3 | 2 | x⁽¹⁾ (i) = d⁽⁰⁾ (2i) | M_{symb}^{layer} = | 2-1c |
| | | x⁽²⁾ (i) = d⁽⁰⁾ (2i + 1) | M_{symb}⁽⁰⁾/2 = | |
| | | x⁽⁰⁾ (i) = d⁽¹⁾ (i) | M_{symb}⁽¹⁾ | |

Alternatively, the UE can signal an index list for each CW, e.g. the first CW should contain layer [0, 2] and the second CW should contain layer [1, 3] for a rank 4 transmission. By letting the UE be able to signal the preferred indices for each CW will make sure to utilize link performance to maximum. The drawback is that it might need more bits signaled, depending on how large the fixed table is large. The fixed table might be very large if it is also extended for ranks higher than 4.

The same methodology can be used for the UE to determine optimal CW to layer mapping as described in 0.

Layer Index Associated with Antenna Configuration (X3)

The first UE could determine the layers associated with the same pair of Xpol from the physical antennas configuration. The Xpol antennas configuration with 4Rx as shown in FIG. 13 gives 2 pairs of Xpol antennas sets. In general the correlation between the same pair of Xpol is much smaller than 2 different pairs of Xpol. The correlation examples defined in 3GPP are from Table. During the CSI processing from the first UE it can be identified which layers are associated with which physical antenna so this information can be stored from every CSI estimation processing.

The format of X3 can be 2 numbers from [1,2,3,4] to represent the layer index to be associated with the same pair of Xpol antennas.

Layer Information to be Combined into Same Codeword (X4)

The first UE could further use the above information X1, X2, X3 to determine which layers are better to be combined into same codeword. For example by taking X3 the first UE can have layers from same pair of Xpol antenna configuration to be combined to same codeword.

The format of X4 can be 2 numbers from [1,2,3,4] to represent the layer index to be combined into same codeword.

Transmitting the Optimized CW to Layer Mapping Information (X) to Network Node

In this step the first UE transmits information related to the value of the parameter for per carrier, X, as obtained and determined in previous sections to one or more network nodes (e.g. first network node, second network node). The aspects related to the reporting of the said information are described below:

Reporting Mechanisms

In one aspect of this embodiment the first UE may report the said information proactively or autonomously whenever the first UE determines any change in the value of parameter, X or periodically or whenever the first UE sends uplink feedback information (e.g. HARQ feedback, measurement report etc).

In another aspect of this embodiment the first UE may report the said information upon receiving a request from the first or the second network node to transmit the said information related to the value of parameter, X. In yet another aspect of this embodiment the first UE may be requested by the first or the second network node to report the said information only if there is any change in the value of parameter for per carrier, X, with respect to the previously determined value of the parameter for per carrier, X.

The first UE may report the said information by using any of the following mechanisms:
In a first type of reporting mechanism, the first UE may transmit the said information in a higher layer signaling such as via RRC message to the first network node or to the second network node. Such information may also be reported in a MAC message.
In a second type of reporting mechanism, the first UE may also use the unused bits or code words or fields or control space or bit pattern or bit combinations (aka spared, reserved, redundant bits or code words or control space or bit pattern or bit combinations etc) for indicating the information related to the determined parameter for per carrier, X to the first or the second network node. This approach may, for example, involve transmitting the information in the physical transmission layer (PHY). Typically using this mechanism the first UE sends the determined information to the first network node (e.g. to the serving base station). The unused bits herein means any set of available bits in an uplink control channel that are not used for indicating the UE about any of uplink transmission parameters e.g. are not used for indicating uplink feedback information such as CSI related information or combined with uplink data and sent by uplink data channel

Validity of Reported Information

The information about the value of X for per carrier reported by the first UE to the first or the second network nodes may be considered valid by the first and the second network nodes for certain time period or time unit (i.e. a predetermined time). Examples of time unit are subframe, TTI (transmission time interval), time slot, frames etc. This may be determined based on one or more pre-defined rule and/or indication from the first UE. Examples of such rules or indications for determining the validity of the said information are:
Information is valid only in time unit in which the information is received at the network node;
Last received information remains valid until the reception of the new information at the network node;
Information is valid for L number of time units starting from a reference time, T, where T can be time when the information is received, a reference time unit (e.g. SFN=0) etc.
Information received in certain time unit (e.g. subframe n) is valid or applicable for subframe n+m, where m is 1 or more integer value.

After the predetermined time has elapsed (or when new information is received) the information may be discarded by the network node(s).

Method in Network Node of Using Information about Status of Optimized CW to Layer Mapping from UE Side

The network node receiving or obtaining the information about the optimized CW to layer mapping information (X) from the first UE may use the said information for performing one or more radio operational or radio resource management tasks as described below. The optimized CW to layer mapping information (X) includes:
The preferred CW to layer mapping information based on existing CW to layer mapping table, aka preferred number of CW from first UE (X1)
An optimized new CW to layer mapping, differently from the existing CW to layer mapping (X2)
Layer index associated with antenna configuration (X3)
Layer information to be combined into same codeword (X4)

The network node can use the received information X directly on the CW to layer mapping step.

Other examples of radio operational or radio resource management tasks are:
Radio resource management: For example the first network node may use the information of X1 into the adaptive scheduling to decide the resource allocation and MCS for the first UE.
Transmitting information to other network nodes: The first network node may also signal the received information to another network node. For example the first network node may send it to the second network node (such as by Node B to RNC over I_{ub} interface in HSPA) and/or to even a third network node (e.g. neighboring base station such as by serving eNodeB to neighboring eNodeB over X interface in LTE) etc. The receiving network node may use the received information for one or more radio tasks. For example the RNC may adapt or modify one or more UEs (first, second or third UEs) with the correlation information provided by the UEs.

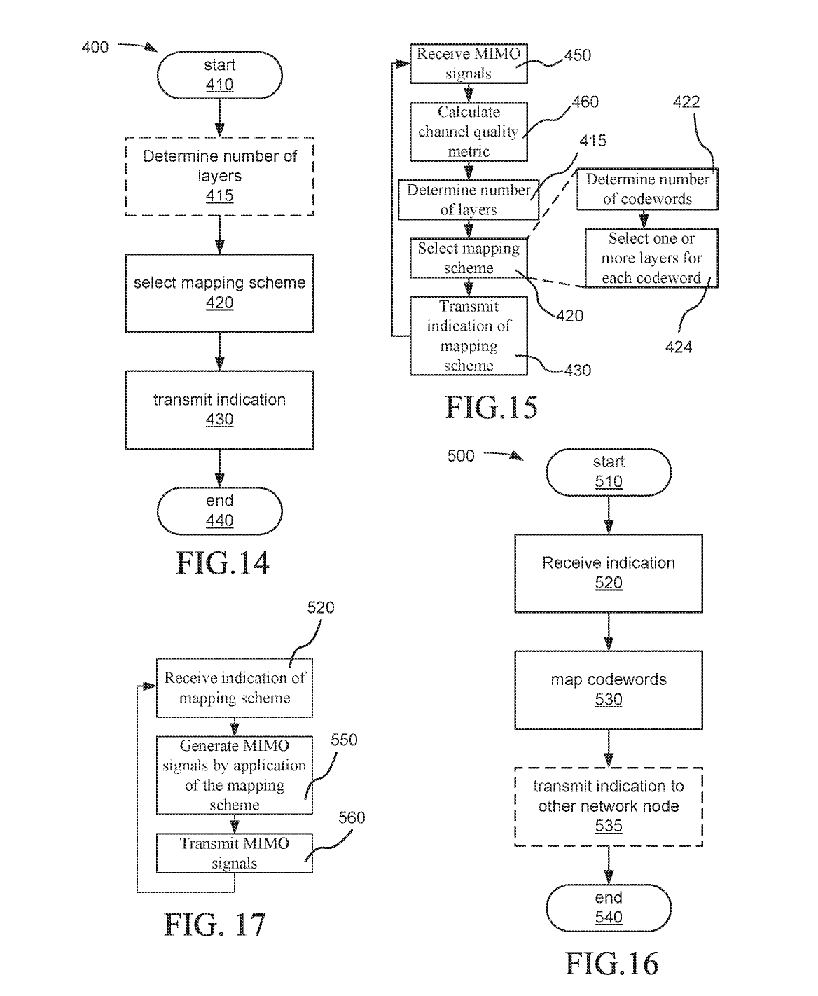

FIGS. 14-15 illustrate methods to be performed in a wireless communication device, which is denoted UE in parts of this detailed description above. FIG. 14 is a flow chart for embodiments of a method 400 of a wireless communication device adapted to receive MIMO signals from a network node of a cellular communication network. As outlined above, the MIMO signals comprises a variable number P of codewords conveyed by a variable number Q of MIMO layers, wherein Q>P and P>1. For example, in some embodiments, P may be equal to 2 and Q may be greater than or equal to 4. The operation is started in step 410. In line with what has been described above, the method 400 comprises, in step 420, selecting a preferred mapping scheme for codeword-to-layer mapping. The preferred mapping scheme is selected among a plurality of available codeword-to-layer mapping schemes. The selection may be based on a preferred number of layers and a channel quality metric related to the transmission of the MIMO signals. Furthermore, the method comprises, in step 430, transmitting an indication of the preferred mapping scheme to the network node. The operation is ended in step 440.

As indicated in FIG. 14, the method may optionally comprise, in step 415, determining the preferred number of layers based on the channel quality metric.

Step 420 may comprise determining a preferred number of codewords. Step 420 may also comprise selecting the preferred mapping scheme based on the preferred number of codewords.

The selection of the preferred mapping scheme in step 420 may be based on the channel quality metric of each of the layers.

In some embodiments, the channel quality metric may comprise a signal-to-interference-and-noise ratio—SINR. Other examples, include SNR (signal-to-noise ratio), SIR (signal-to-interference ratio), and functions of SINR, SNR or SIR (e.g. associated with channel capacity). When any of these metrics are referred to herein, it is to be understood that any suitable one of the other metrics may be used instead. As has been outlined above, the selection of the mapping may be based on differences in, or variation of, the channel quality metric, such as differences in, or variation of, SINR between the different layers.

In some embodiments, according to the preferred mapping scheme, each codeword is mapped to a number—q—of layers and q is based on an inverse of the channel quality metric of the layers. For example, if there are 4 layers and 2 codewords and a first layer has considerably better channel quality metric than the other three layers, one codeword may be conveyed by the first layer and the other codeword may be conveyed by the other three layers.

FIG. 15 is a flow chart of an embodiment of a method that includes steps of an embodiment of the method 400 (FIG. 14). In step 450, MIMO signals are received from the network node. In step 460, the channel quality metric is calculated for each of the layers. Then, steps 415, 420, and 430, already described in the context of FIG. 14, are performed, and the operation returns to step 450. In the embodiment illustrated in FIG. 15, step 420 includes the steps 422 of determining a preferred number of codewords, and 424 of selecting the preferred mapping scheme is further based on the preferred number of codewords in terms of selecting one or more layers for each codeword.

FIGS. 16-17 illustrate methods to be performed in a network node. FIG. 14 is a flow chart for embodiments of a method 500 of a network node of a cellular communication network. The network node is adapted to transmit MIMO signals to a wireless communication device. As described in the context of FIGS. 14-15, the MIMO signals comprise a variable number P of codewords conveyed by a variable number Q of MIMO layers, wherein Q>P and P>1. Again, for example, P may be equal to 2 and Q may be greater than or equal to 4. The operation is started in step 510. In line with what has been described above, the method 500 comprises, in step 520, receiving, from the wireless communication device, an indication of a preferred mapping scheme for codeword-to-layer mapping. The preferred mapping scheme has been selected by the wireless communication device among a plurality of available codeword-to-layer mapping schemes, e.g. in accordance with any of the embodiments described above with reference to FIGS. 14-15. Furthermore, the method 500 comprises, in step 530, mapping the codewords to the MIMO layers according to the preferred mapping scheme for generation of the MIMO signals. The operation is ended in step 540. As indicated in FIG. 16, the method 500 may optionally include the step 535 of transmitting the received indication to another network node, as mentioned above.

FIG. 17 is a flow chart of an embodiment of a method that includes steps of an embodiment of the method 500 (FIG. 16). In step 520, already described with reference to FIG. 16, the indication of the preferred mapping is received. In step 550, MIMO signals are generated by application of the preferred mapping scheme. Step 550 may include step 530, described with reference to FIG. 16. In step 560, the MIMO signals are transmitted to the wireless communication device. The operation then returns to step 520.

Although steps are illustrated in FIGS. 14-17 as being performed in sequence, some of them may in practice be performed in parallel. In particular, the step 450 of receiving MIMO signals may be a more or less continually ongoing process going on in parallel with other steps in the wireless communication device Similarly, the step 560 of transmitting MIMO signals may be a more or less continually ongoing process going on in parallel with other steps in the network node. It should also be noted that the network node may discard the preferred mapping scheme, e.g. after a predetermined time or when a new indication of preferred mapping scheme is received.

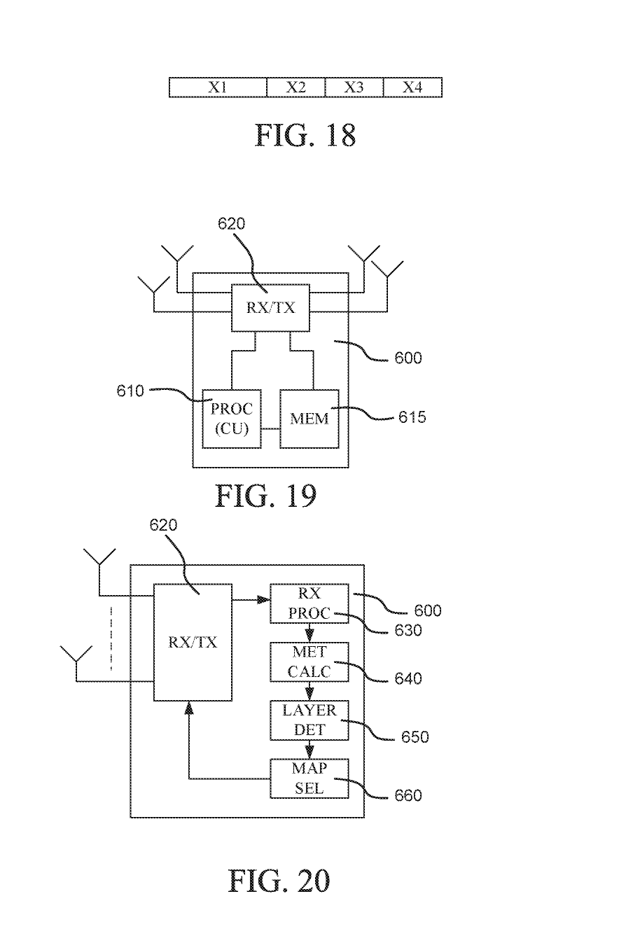

In some embodiments, the indication of the preferred mapping scheme is transmitted in one of a radio resource control—RRC—message, a media access control—MAC—message, and one or more physical transmission layer—PHY—bits. In some embodiments, the indication of the preferred mapping scheme comprises one or more of the preferred number of layers, the preferred number of codewords (e.g. conveyed by the information labeled X1 above), an identification of the codeword-to-layer mapping (e.g. conveyed by the information labeled X2 above), an identification of layers being associated with a same antenna pair (e.g. conveyed by the information labeled X3 above), an identification of layers to be combined to convey a same codeword (e.g. conveyed by the information labeled X4 above). An example of arrangement of the information elements X1, X2, X3, and X4 in a message to be transmitted to the network node is provided in FIG. 18.

Some embodiments concern a wireless communication device 600 adapted to receive MIMO signals from a network node of a cellular communication network. As above, the MIMO signals comprises a variable number P of codewords conveyed by a variable number Q of MIMO layers, where Q>P and P>1. The wireless communication device may, according to some embodiments, be arranged to perform any of the embodiments of the methods described with reference to FIGS. 14-15. FIGS. 19-20 illustrate some embodiments of the wireless communication device 600.

FIG. 19 is a simplified block diagram of the wireless communication device 600 according to some embodiments. The wireless communication device 600 comprises a control unit, which in FIG. 19 is illustrated as a processor 610 connected to a memory 615. The control unit is adapted to select a preferred mapping scheme for codeword-to-layer mapping based on a preferred number of layers and a channel quality metric related to the transmission of the MIMO signals from the network node to the wireless communication device 600. As above, the preferred mapping scheme is selected among a plurality of available codeword-to-layer mapping schemes. Furthermore, the wireless communication device comprises a transmitter, in FIG. 19 illustrated as embedded in a transceiver 620. The transmitter is adapted to transmit an indication of the preferred mapping scheme to the network node. This indication has been discussed in the context of the methods described above with reference to FIGS. 14-17. This discussion is not further repeated herein. The transceiver 620 may also comprise a receiver for receiving MIMO signals from the network node.

In line with what was described above in the context of the methods with reference to FIGS. 14-15, the control unit, such as processor 620, may be adapted to determine the preferred number of layers based on the channel quality metric. As above, the selection of the preferred mapping scheme may be based on the channel quality metric of each of the layers.

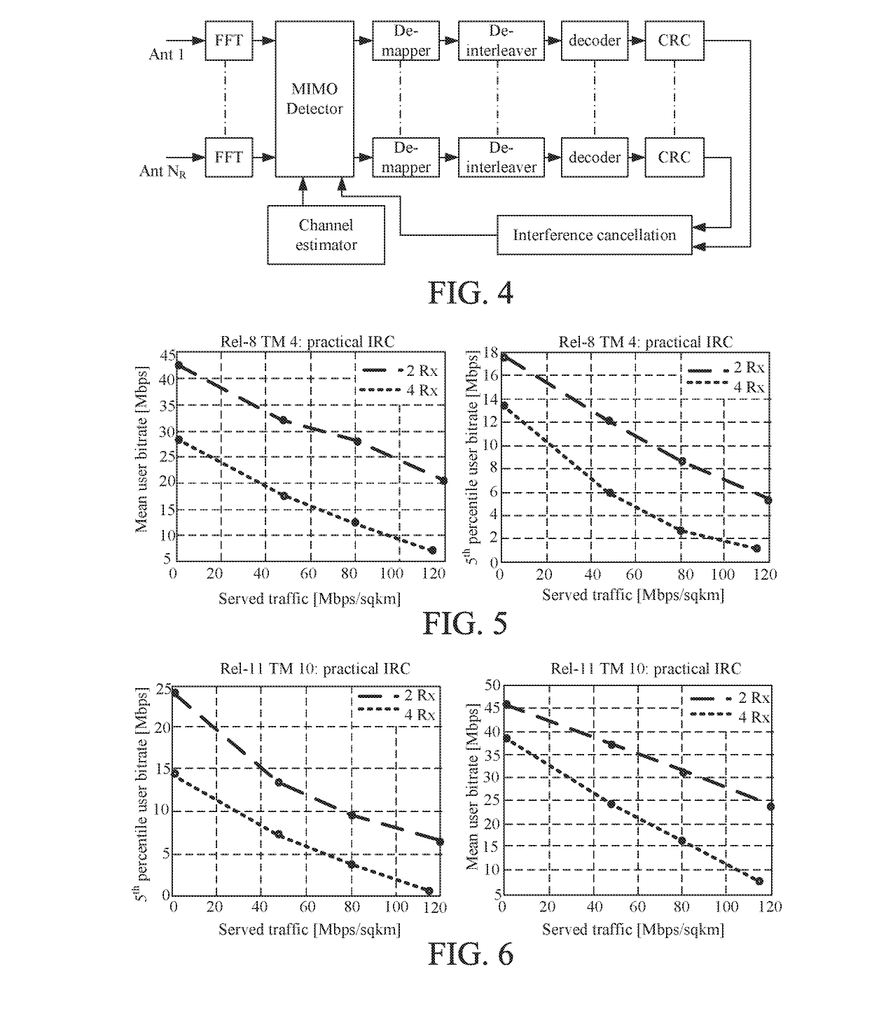

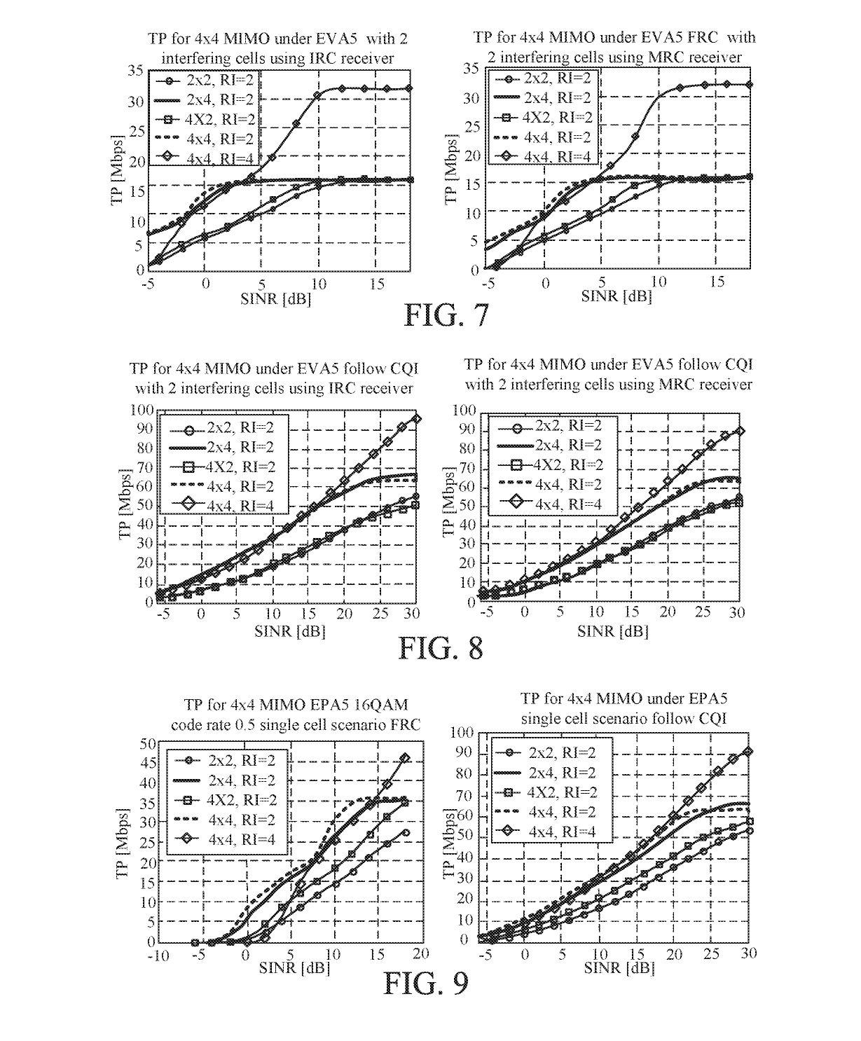

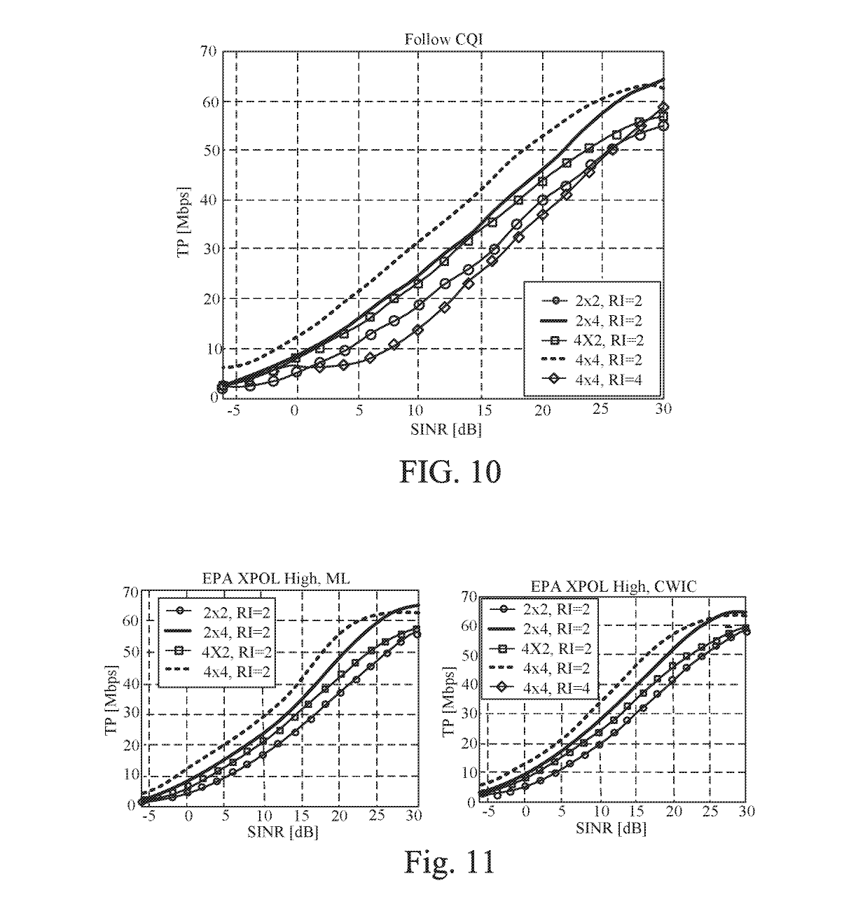

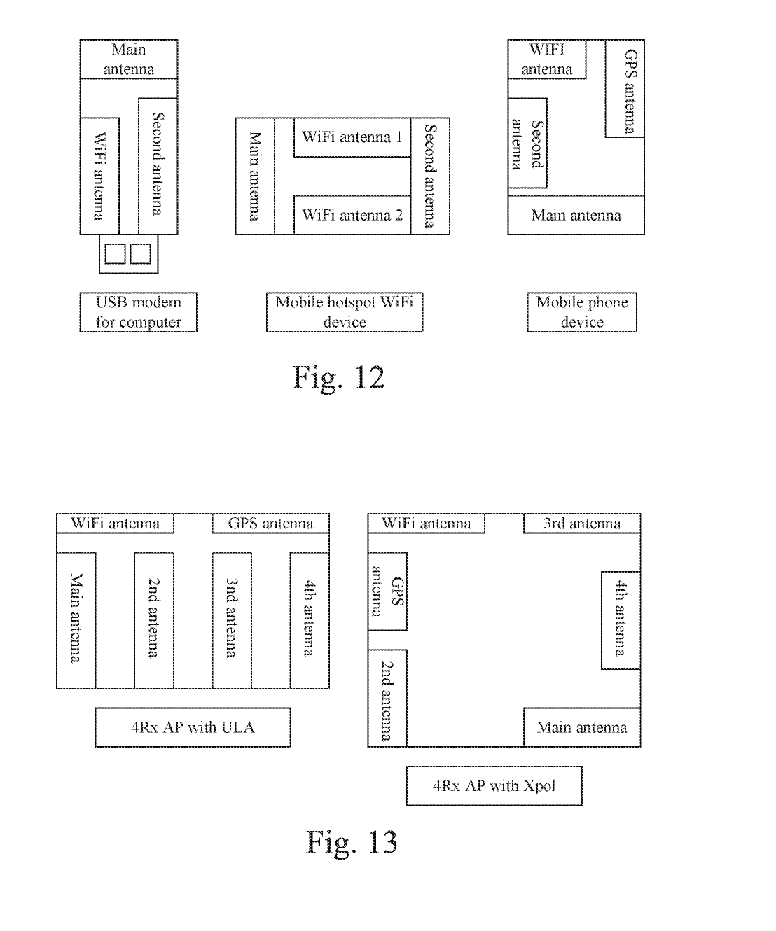

FIG. 20 is another block diagram of an embodiment of the wireless communication device 600. It comprises the transceiver 620 already described with reference to FIG. 19. Furthermore, it comprises a receive processing unit 630, a metric calculation unit 640, a layer determination unit 650, and a mapping selection unit 660. The receive processing unit 630 may be adapted to process received MIMO signals, e.g. by performing one or more of the functions illustrated in FIG. 4. The metric calculation unit 640 may be adapted to calculate the channel quality metric for each of the layers. The layer determination unit 650 may be adapted to determine the preferred number of layers. The mapping selection unit 660 may be adapted to select the preferred mapping scheme for codeword-to-layer mapping based on the preferred number of layers and the channel quality metric. One, more, or all of the units 630, 640, 650, and 660 may be implemented with instructions executed on a processor, such as the processor 610 (FIG. 19).

Some embodiments concern a network node 700 of a cellular communication network. The network node is adapted to transmit MIMO signals to a wireless communication device, e.g. the wireless communication device 600 (FIGS. 19-20). As above, the MIMO signals comprises a variable number P of codewords conveyed by a variable number Q of MIMO layers, where Q>P and P>1. The network node 700 may, according to some embodiments, be arranged to perform any of the embodiments of the methods described with reference to FIGS. 16-17.

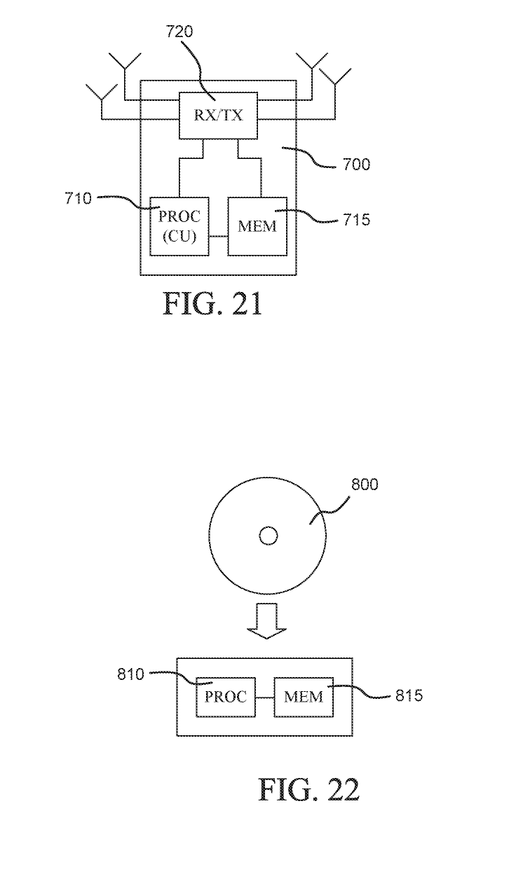

FIG. 21 is a simplified block diagram of the network node 700 according to some embodiments. It comprises a receiver, in FIG. 21 illustrated as embedded in a transceiver 720. The receiver is adapted to receive, from the wireless communication device, the indication of the preferred mapping scheme for codeword-to-layer mapping. The preferred mapping scheme has been selected by the wireless communication device among a plurality of available codeword-to-layer mapping schemes, e.g. in accordance with any of the embodiments described above with reference to FIGS. 14-15. Furthermore, the network node 700 comprises a control unit, which in FIG. 21 is illustrated as a processor 710 connected to a memory 715. The control unit is adapted to map the codewords to the MIMO layers according to the preferred mapping scheme for generation of the MIMO signals. The transceiver 720 may comprise a transmitter adapted to transmit the MIMO signals to the wireless communication device. The transceiver 720 may alternatively or additionally comprise a transmitter, which may be a wireless or wireline transmitter, adapted to transmit the received indication to another network node.

In some embodiments, the control unit is adapted to discard the preferred mapping scheme, e.g. after a predetermined time or when a new indication of preferred mapping scheme is received.

The mentioning of Q>P and P>1 is used herein to indicate that the disclosure concerns how the codeword-to-layer mapping is to be performed for these particular values of P and Q, but does not limit the operation of the wireless communication device or the network node to these values. The wireless communication device and network node may be capable of communicating with other values of P and Q as well, such as Q=P and/or P=1, e.g. using well established and standardized procedures.

The described embodiments and their equivalents may be realized in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a wireless communication device or a network node) comprising circuitry/logic or performing methods according to any of the embodiments.

According to some embodiments, a computer program product comprises a computer readable medium. The computer readable medium may have stored thereon a computer program comprising program instructions. The computer program may be loadable into a data-processing unit, which may, for example, be comprised in a wireless communication device or a network node. When loaded into the data-processing unit, the computer program may be stored in a memory associated with or integral to the data-processing unit. According to some embodiments, the computer program may, when loaded into and run by the data-processing unit, cause the data-processing unit to execute method steps according to, for example, the methods shown in any of the Figures and/or described herein. This is illustrated in FIG. 22, showing such a computer-readable medium 800, data-processing unit 810, and memory 815. The data-processing unit 810 may e.g. be the processor 610 (FIG. 19) or the processor 710 (FIG. 21). The memory 815 may then be the memory 615 (FIG. 19) or the memory 715 (FIG. 21), respectively.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1. A method of a wireless communication device adapted to receive multiple-input multiple-output—MIMO—signals from a network node of a cellular communication network, the MIMO signals comprising a variable number—P—of codewords conveyed by a variable number—Q—of MIMO layers wherein Q is larger than P and P is larger than 1, the method comprising:
selecting a preferred mapping scheme for codeword-to-layer mapping based on a preferred number of layers and a channel quality metric related to the transmission of the MIMO signals, the preferred mapping scheme being selected among a plurality of available codeword-to-layer mapping schemes; and
transmitting an indication of the preferred mapping scheme to the network node.

2. The method of claim 1 further comprising determining the preferred number of layers based on the channel quality metric.

3. The method of any of claims 1 through 2 wherein selecting the preferred mapping scheme comprises determining a preferred number of codewords.

4. The method of claim 3 wherein selecting the preferred mapping scheme is further based on the preferred number of codewords.

5. The method of claim 1 wherein the selection of the preferred mapping scheme is based on the channel quality metric of each of the layers.

6. The method of claim 5 wherein, according to the preferred mapping scheme, each codeword is mapped to a number—q—of layers and q is based on an inverse of the channel quality metric of the layers.

7. The method of claim 1 wherein the channel quality metric comprises a signal-to-interference-and-noise ratio—SINR.

8. The method of claim 1 wherein the indication of the preferred mapping scheme comprises one or more of:
the preferred number of layers;
the preferred number of codewords;
an identification of the codeword-to-layer mapping;
an identification of layers being associated with a same antenna pair; and
an identification of layers to be combined to convey a same codeword.

9. The method of claim 1 wherein the indication of the preferred mapping scheme is transmitted in one of a radio resource control—RRC—message, a media access control—MAC—message, and one or more physical transmission layer—PHY—bits.

10. The method of claim 1 wherein P is equal to 2 and Q is greater than or equal to 4.

11. A method of a network node of a cellular communication network, the network node adapted to transmit multiple-input multiple-output—MIMO—signals to a wireless communication device, the MIMO signals comprising a variable number—P—of codewords conveyed by a variable number—Q—of MIMO layers, wherein Q is larger than P and P is larger than 1, the method comprising:
receiving, from the wireless communication device, an indication of a preferred mapping scheme for codeword-to-layer mapping, wherein the preferred mapping scheme has been selected by the wireless communication device among a plurality of available codeword-to-layer mapping schemes based on a preferred number of layers and a channel quality metric related to the transmission of the MIMO signals; and
mapping the codewords to the MIMO layers according to the preferred mapping scheme for generation of the MIMO signals.

12. The method of claim 11 wherein the indication of the preferred mapping scheme comprises one or more of:
the preferred number of layers;
the preferred number of codewords;
an identification of the codeword-to-layer mapping;
an identification of layers being associated with a same antenna pair; and
an identification of layers to be combined to convey a same codeword.

13. The method of claim 11 wherein the indication of the preferred mapping scheme is received in one of a radio resource control—RRC—message, a media access control—MAC—message, and one or more physical transmission layer—PHY—bits.

14. The method of claim 11 wherein P is equal to 2 and Q is greater than or equal to 4.

15. The method of claim 11 further comprising discarding the preferred mapping scheme after a predetermined time or when a new indication of preferred mapping scheme is received.

16. The method of claim 11 further comprising transmitting the received indication to another network node.

17. A computer program product comprising a computer readable medium, having thereon a computer program comprising program instructions, the computer program being loadable into a data-processing unit and adapted to cause execution of the method of claim 1 when the computer program is run by the data-processing unit.

18. A wireless communication device adapted to receive multiple-input multiple-output—MIMO—signals from a network node of a cellular communication network, the MIMO signals comprising a variable number—P—of codewords conveyed by a variable number—Q—of MIMO layers wherein Q is larger than P and P is larger than 1, the wireless communication device comprising:
a control unit adapted to select a preferred mapping scheme for codeword-to-layer mapping based on a preferred number of layers and a channel quality metric related to the transmission of the MIMO signals, the preferred mapping scheme being selected among a plurality of available codeword-to-layer mapping schemes; and
a transmitter adapted to transmit an indication of the preferred mapping scheme to the network node.

19. The wireless communication device of claim 18 wherein the control unit is further adapted to determine the preferred number of layers based on the channel quality metric.

20. The wireless communication device of claim 18 wherein the selection of the preferred mapping scheme is based on the channel quality metric of each of the layers.

21. A network node of a cellular communication network, the network node adapted to transmit multiple-input multiple-output—MIMO—signals to a wireless communication device, the MIMO signals comprising a variable number—P—of codewords conveyed by a variable number—Q—of MIMO layers, wherein Q is larger than P and P is larger than 1, the network node comprising:
a receiver adapted to receive, from the wireless communication device, an indication of a preferred mapping scheme for codeword-to-layer mapping, wherein the preferred mapping scheme has been selected by the wireless communication device among a plurality of available codeword-to-layer mapping schemes based on a preferred number of layers and a channel quality metric related to the transmission of the MIMO signals; and
a control unit adapted to map the codewords to the MIMO layers according to the preferred mapping scheme for generation of the MIMO signals.

22. The network node of claim 21 wherein the control unit is further adapted to discard the preferred mapping scheme after a predetermined time or when a new indication of preferred mapping scheme is received.

23. The network node of claim 21 further comprising a transmitter adapted to transmit the received indication to another network node.
